(19) United States
(12) Patent Application Publication
(10) Pub. No.: US 2003/0211791 A1
(43) Pub. Date: Nov. 13, 2003

(54) Flow guiding structure

(75) Inventor: Wen-Kuang Wu, TaoYuan Hsien (TW)

Correspondence Address: DOUGHERTY & TROXELL, SUITE 1404, 5205 LEESBURG PIKE, FALLS CHURCH, VA, 22041, US

(73) Assignee: MEMSFUEL INTERNATIONAL CORPORATION

(21) Appl. No.: 10/140,198

(22) Filed: May 8, 2002

(51) Int. Cl. D04H 1/00; B32B 3/04; B32B 27/04; B32B 5/26; B32B 15/08; D03D 19/00; D03D 15/00; D03D 9/00

(52) U.S. Cl. 442/6; 442/19; 442/32; 428/130

(57) ABSTRACT

The invention is a flow guiding structure that is applied in a heat transfer apparatus which has no any driving power and it is a structure of subsystem to guide the flow direction of a fluid and it is also belonged to a passive and brought along system that can not be applied independently. The structure is comprised of at least one metal network and a working fluid. Through the symmetrical inlet and outlet for the flow paths of the fluid, the structure is connected and applied to the main system that is so-called a heat exchanging system, such as: any refrigeration, air-conditioning system, and looping heat pipe referred in the invention. The metal network structure is laminated compactly by plural net surfaces woven crosswise by metal threads and the porous structure of regular distribution has the hydrophile characteristic so that, when the fluid of the main system passes this structure, it will be adsorbed on the metal network by the surface tension of capillarity generated on the meshes on the metal net surfaces.

### FIELD OF THE INVENTION

The invention relates to a flow guiding structure, particularly to a subsystem that is belonged to a heat dissipation apparatus of micro circulation for guiding the flow direction of the fluid therein without any driving power.

### BACKGROUND OF THE INVENTION

Please refer to FIG. 1, in which a flow guiding structure according to prior arts is applied in a heat dissipation apparatus, of which a metal closure structure containing a fluid 15 forms a circulation flow path 13 therein and also includes a heat dissipation zone 17 and a heat absorption zone 16, in which a flow guiding structure 11 made of powder metallurgy is arranged. Wherein, the function of the flow guiding structure 11 is to increase the surface area inside the heat absorption zone 16. After being heated, the fluid 15 in the heat absorption zone 16 is vaporized to generate a pressure source, by which the vaporized fluid 15 is pushed toward the heat dissipation zone 17 and, through the heat dissipation, the vaporized fluid 15 is condensed to liquid state, and the liquid fluid 15 reenters the flow guiding flow structure 11 to start another flow circulation.

However, the size of the interior clearance of the flow guiding structure 11 made by powder metallurgy is uneven, so that the flow behavior in the flow guiding structure 11 is irregular and it is impossible to mass production and guide it into current market. Further, the flow guiding structure 11 made by powder metallurgy has no flexibility, so that it is impossible to make the outer layer of the metal membrane 12 contact flexibly with the element of the electric appliance to be dissipated heat. For the formation of the entire system, the flow guiding structure 11 must be welded onto the metal membrane 12 by the traditional welding method for pipes, so that relatively the process is difficult and the cost is also higher.

Furthermore, it is also questionable that the fluid 15 in the heat dissipation apparatus mentioned thereinbefore will flow in the single direction as expected, because this structure is a heat transfer apparatus that has no any driving power source and the only mechanisms are the internal flow path 13 arranged in the closure space and the capillary phenomenon of the two phases change of the fluid 15 to transfer the heat. Therefore, the regularity of the flow fields inside the flow guiding structure 11 will influence the effect of the entire flow guidance and will also influence the heat dissipation efficiency of the main system.

### SUMMARY OF THE INVENTION

Accordingly, in order to overcome the shortcomings of the flow guiding structure described in the prior arts, through continuous improvement and innovation, the inventor has finally proposed a flow guiding structure, which is mainly comprised of a metal network and a fluid, and is connected and applied in the main system with the symmetrical inlet and outlet for the flow paths of the fluid. The metal network is comprised of uniform meshes woven crosswise by metal threads to compose an even porous structure laminated compactly. After being cooled through the heat dissipation treatment, the fluid of the main system enters the structure and is adsorbed evenly on each layer. Since the multi-layer network is structured regularly and connected compactly but not melted together, so this uniform distribution of hydrophile structure is particularly adapted for the micro-systems. The meshed structure is enclosed by the metal membrane of the main system and, when the capillary function inside the porous structure of the heat pipe system of the main loop is generated, it is convenient for the flow guiding structure to absorb the fluid from the condensing pipes. Furthermore, because of the particular design of the thin pipes of the heat pipe system of micro-loop and, after the guided fluid being heated in the interior of the structure and changed phase, the vaporized fluid is guided out the structure smoothly and enters the guiding pipes of the main heat transfer system.

Most of the fluid in the heat transfer apparatus of main system loop is contained in the metal network structure that is the strongest hydrofile position for the entire system. Through the surface tension of the compact meshes of the multiple layers of the metal network mentioned thereinbefore, the fluid in the structure after being heated and vaporized can only just flow in parallel between the net surfaces and move toward the surroundings of the structure and ascend therein to the top of the structure. The flow guiding structure is formed by designing one end of the communication ports as one entrance port of the fluid from the cooling pipes of the main system (after the heated and vaporized fluid being cooled and condensed in the heat dissipation zone, the liquid will pass through the larger pipes of smaller pressure and flow back to the flow guiding apparatus by the capillary force), while another end of the communication ports is designed as a single outlet for the ascending vapor exiting to the thin flow path of the main system.

The main object of the invention is to provide a flow guiding structure of metal network, which guides the flow direction of the vaporized fluid contained therein by the surface tension of uniform distribution generated from the regular structure.

The secondary object of the invention is to provide a flexible application, which may be matched with the interface of other structure by using the flexible characteristic of the metal network.

For your esteemed review committee to understand the operational principle and other function in a more clear way, a detailed description in cooperation with corresponding drawings are presented as follows.

### BRIEF DESCRIPTION OF THE DRAWINGS

FIG. 1 is an illustration for a flow guiding structure according to the prior arts applied in a heat dissipation apparatus.

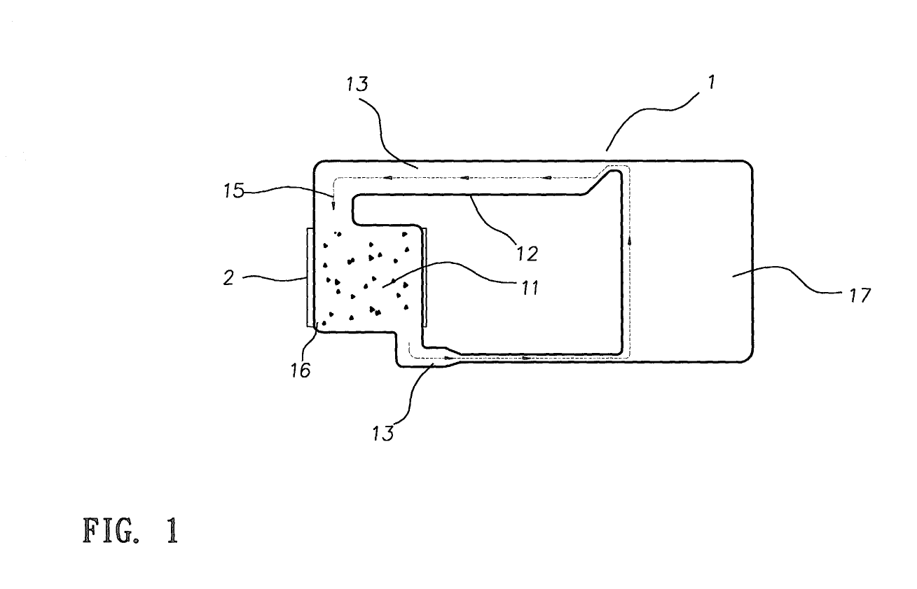

FIG. 2A is a flow guiding structure according to the invention.

FIG. 2B is a method for laminating a three-dimensional structure by the porous structure according to the invention.

FIG. 2C is another method for laminating a three-dimensional structure by the porous structure according to the invention.

FIG. 3 is an illustration for the vaporization paths of the fluid in the network structure.

FIG. 4 is the flow guiding structure according to the invention applied in a heat pipe apparatus of micro-loop.

### DETAILED DESCRIPTION OF THE PREFERRED EMBODIMENTS

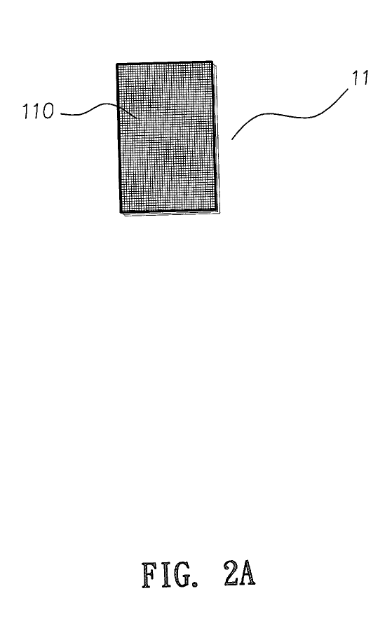

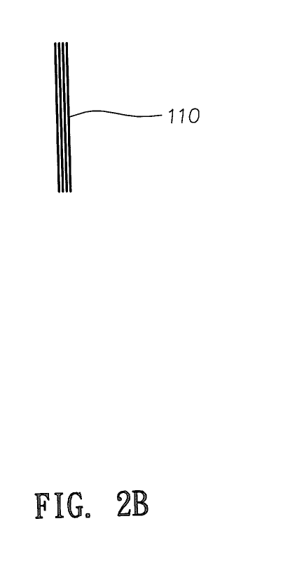

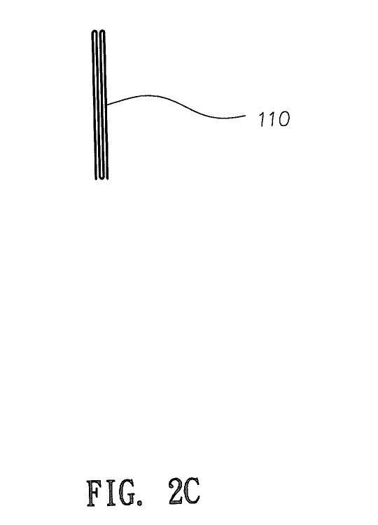

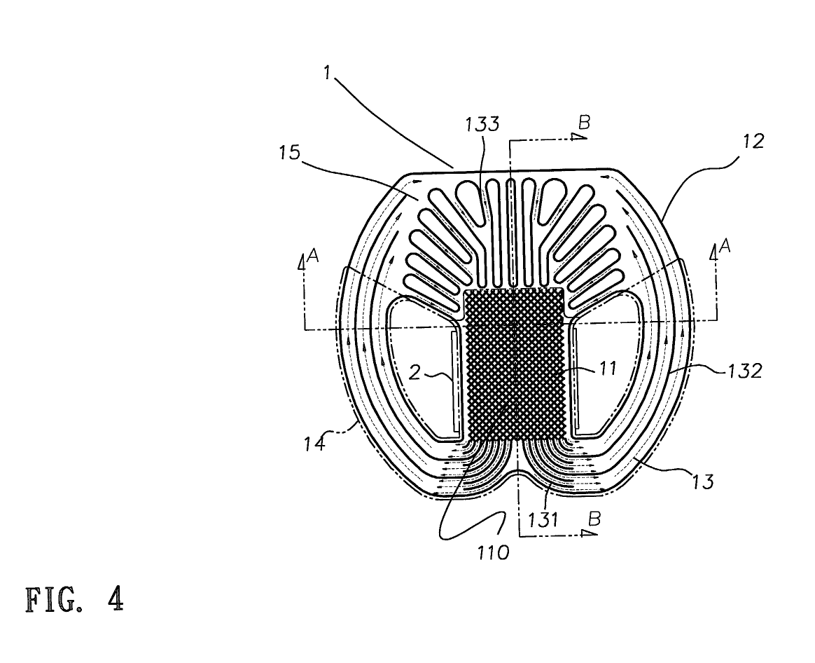

Please refer to FIG. 2A and FIG. 4, in which the invention provides a flow guiding apparatus of metal network 11 to guide the heat transfer in the micro-loop of the heat pipe of the main system 1 with the separate fluid behavior of two phases flow, wherein a regular behavior of the vaporization is generated by a regularly organized structure. The structure of the invention is mainly comprised of at least one metal network 110 and a fluid 15, and is connected with the cooling pipes 133 and the thin pipes 131 of the main system 1 respectively with the symmetrical inlet and outlet for the liquid and vapor of the fluid 15.

The metal network 110 is woven crosswise by the metal threads that are made of at least one material possessing the high flexibility the high heat conductance, such as: gold, silver, copper, and aluminum, etc. The diameter of the metal thread may be varied according to the actual needs. The structure of the invention is composed and connected by the network structure of the multiple plane layers, and the mesh density of each laminated lay is equivalent. As shown in FIG. 2C, the above three-dimensional structure may be formed by folding a single metal net several times. As shown in FIG. 2B, the above three-dimensional structure may be laminated by the multiple layers of the metal net. Each layer of the formed three-dimensional structure has equivalent surface tension to provide the liquid with a stable adsorptive force during heating.

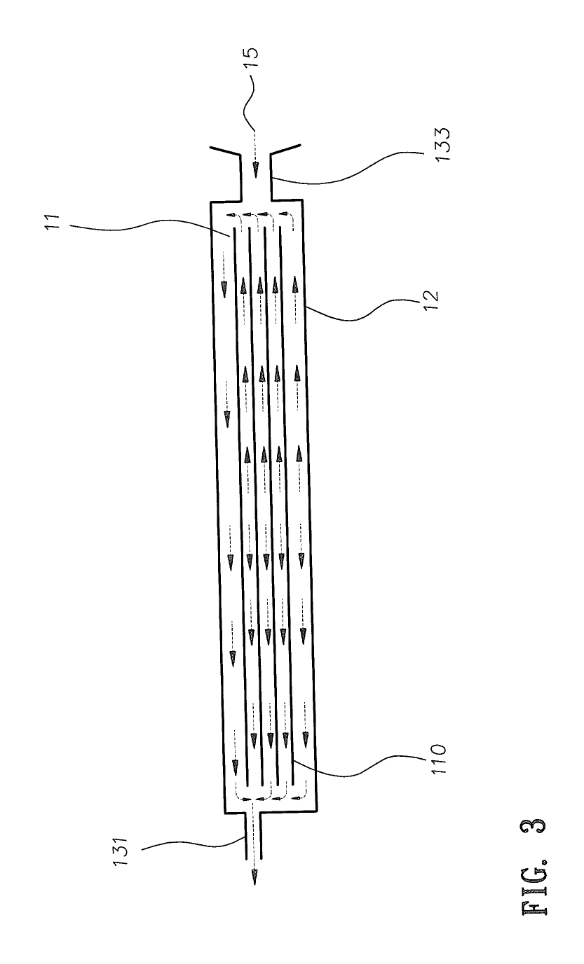

Please refer to FIG. 3 and, when the fluid in the flow guiding system 11 is heated (the critical temperature of vaporization reaches the boiling point), the vapor molecular moves between the metal net layers 11 in parallel. Because of the limitation of the metal membrane 12 of the outer shell, the vapor molecular ascends upwardly only in the surrounding space, so that the ascending vapor molecular moves toward the top of the system and the fluid 15 of liquid state is adsorbed on the meshed structure by its stable surface tension and, therefore, the main step for creating the two phases flow is completed. Since the fluid 15 of the heat transfer apparatus 1 flows back to the structure 11 from the cooling pipes 133 by the capillary function, so the vaporized fluid 15 accumulated at the top of the flow guiding structure is forced to move out from the subsystem 11 and enters the thin pipes 131 of the main system 1. Because of the entrance of the fluid 15 of liquid phase, the interior temperature of the flow guiding system 11 is lowered down, so that the circumstantial temperature is maintained within the critical ranges, i.e., below the boiling point.

The application of the flow guiding structure 11 according to the invention to a heat dissipation apparatus of micro-loop 1 is described as follows.

Please refer to FIG. 4, which is the distribution situation of the fluid 15 in the flow guiding structure 11 and, when the heat dissipation apparatus of micro-loop 1 is not contacted with the element of the electric appliance 2 to be dissipated heat. Absorbed in the network 110, the fluid 15 is heated by the metal membrane 12 and, then the vaporized fluid 15 flows out the thin pipe 131 due to internal pressure and the surface tension of the meshes in the network 110. After the heat dissipation and the cooling treatment, the vaporized fluid 15 is condensed to liquid state and flows back to the structure 11 through the cooling pipes 133 and by the application of capillarity. When the heat dissipation apparatus of micro-loop 1 is contacted with the element of the electric appliance 2 to be dissipated heat, the heat is transferred from the metal membrane 12 to the flow guiding structure 11, in which the absorbed heat is distributed uniformly to the fluid 15 contained in the metal network 110. The heat is carried out through the thin pipes 131 by the vaporized fluid 15 and, then the wasted heat is released in the heat dissipation zone. After releasing the heat, the vaporized fluid 15 is condensed to liquid state, and the liquidized fluid flows back to the structure 11 through the cooling pipes 133.

In above application, the flow guiding structure 11 adsorbs and drives the fluid 15 with the surface tension generated from its particular and uniform structure. However, it is impossible for the flow guiding structure 11 made by the prior method of powder metallurgy to achieve this object.

Further, the invention provides a flexible application, which may be matched with other structure by using the flexible characteristic of the metal membrane 12. As described in above, the flow guiding structure 11 according to the invention is composed of the metal network 110, with which the above metal membrane 12 may make a flexible deformation to be contacted compactly with the element to be dissipated heat, while the flow guiding structure 11 made by the prior method of powder metallurgy is a rigid structure and, therefore, it can not achieve the same flexible effect as that of the invention.

In summary, the flow guiding structure according to the invention is composed of metal threads that are woven into net surfaces with meshes of same size. The clearances between the porous structure unit formed in the laminated structure of the multiple layers have equivalent hydrophile forces and, therefore the stability of the fluid in the flow guiding system is promoted and, when the fluid contained in this structure is heated, it won't influence the behavior of vapor or even mix up the two phases (i.e., liquid and vapor phases) so that, when the fluid is heated and vaporized, we can guide the fluid of two phases separately.

What is claimed is:

1. A flow guiding structure, which is comprised of:
at least a metal net, which is woven crosswise by metal threads, and which is formed into a net structure of multiple layers with same size of meshes by laminating each layer compactly and uniformly with pressure but not melting them; and
a fluid, which is contained in the layer surface of the metal net and adsorbed therein by a uniform surface tension generated from said even metal meshes.

2. The flow guiding structure according to claim 1, wherein multiple layers of said metal net may be laminated up and formed into a three-dimensional structure.

3. The flow guiding structure according to claim 2, wherein said three-dimensional structure may be laminated up by plural single metal net.

4. The flow guiding structure according to claim 2, wherein said three-dimensional structure may be laminated up by different metal nets.

5. The flow guiding structure according to claim 2, wherein said three-dimensional structure may be laminated and folded by a single metal net.

6. The flow guiding structure according to claim 2, wherein said metal net of multiple layers is jointed by heat, so that the contacting point between each metal net is connected by thermal melt but not melted together completely.

7. The flow guiding structure according to claim 1, wherein the diameter of said metal thread may be varied.

8. The flow guiding structure according to claim 1, wherein said metal thread is made of material possessing high heat conductance.

9. The flow guiding structure according to claim 7, wherein said material of high heat conductance is at least one of gold, silver, copper, and aluminum, etc.
